(19) United States
(12) Patent Application Publication
(10) Pub. No.: US 2017/0095402 A1
(43) Pub. Date: Apr. 6, 2017

(54) Moveable Feet-walking Massage Grabbing Bar Rack

(71) Applicant: Qinglin Qiu, Broomfield, CO (US)

(72) Inventor: Qinglin Qiu, Broomfield, CO (US)

(21) Appl. No.: 14/874,455

(22) Filed: Oct. 4, 2015

(51) Int. Cl. A61H 37/00; A61H 39/04

(52) U.S. Cl. CPC A61H 37/00; A61H 39/04; A61H 2201/1284; A61H 2203/0456; A61H 2205/081

(57) ABSTRACT

A lightweight, height-adjustable, moveable feet-massage grabbing bar rack erectable at a desired location to administer ahiatsu to patients. The rack includes first and second side stands positional on either side of a patient. A grabbing bar assembly is securable spanning between the first and second side stands to rigidly maintain the rack upright and supportively uphold a massager engaging each of a pair of parallel bars underarm while administering ahiatsu alongside a patient's back. The grabbing bar assembly is securable between a range of positions to accommodate particular heights appropriate to the needs of particular patients, massage locations, and massagers. The rack is readily disassembled for portage when desired.

### CROSS-REFERENCE TO RELATED APPLICATIONS

This nonprovisional application claims the benefit of provisional application No. 62/068,676 filed on Oct. 25, 2014

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### TO ALL WHOM IT MAY CONCERN

Be it known that I, Qinglin Qiu, a citizen of the United States, have invented new and useful improvements in a moveable feet-massage grabbing bar rack as described in this specification and that I claim the benefit of provisional application No. 62/068,676 filed on Oct. 25, 2014.

### BACKGROUND OF THE INVENTION

Walking massage has been practiced for more than a millennium in Asia wherein a massager walks alongside the spine of a prostrate patient to decompress the vertebrae and increase blood flow throughout the spine and associated muscles. To control weight, and prevent injury to the patient, the massager typically manually engages a transverse beam or support overhead, whereby the massager is enabled to uphold their weight and apply pressure as desired during the massage.

Such transverse beams or supports typical in the art are permanently installed, positioned overhead of the massager, and are not readily adjustable to a desired height for use with patients prostrate upon different surfaces or for use between massagers of varying stature. Moreover, the overhead situation typical of most such supports exerts stresses on the massager's arms during the performance of the massage.

What is needed is a readily portable, expediently erectable, and height adjustable moveable feet-massage grabbing rack for use at various locations, between various massagers and patients, and adjustable to enable underarm support of a massager, knee massage, and feet massage without disturbing the comfort of the patient.

The present invention, therefore, enables erection of a moveable feet-massage grabbing rack adjacent a massage table, bed, tabletop, mat, or other raised structure or ground surface, as case may be, to securably position a grabbing bar assembly transversely spanned between each of a first and second side stand, whereby engagement of each of a pair of parallel bars manually and underarm enables a massager to self-support themself during a walking-feet massage and adjust the position of the grabbing bar assembly between a range of positions appropriate for use with patients prostrate upon a raised surface or a ground surface, as case may be, and to desirously reposition the grabbing bar assembly effective for both feet and knee massages.

### FIELD OF THE INVENTION

The present invention relates to a a portable frame securable to position a grabbing bar assembly spanned over a desired location whereby a user is enabled to support themself at a desired height by manual engagment of a pair of parallel bars to control weight applied to a prostrate patient's back during ashiatsu.

The present invention is lightweight, portable, erectable, and expediently adjustable wherein the grabbing bar assembly is positional between a range of positions appropriate for use with patients lying prostrate upon a ground or raised surface, and between massagers of different statutres, as case may be. The present invention thus relates to the massage arts—particularly ahiatsu, “walking-feet massage”—and support of a human body upon an erectable frame for administration of ahiatsu.

### SUMMARY OF THE INVENTION

The general purpose of the moveable feet-massage grabbing bar rack, described subsequently in greater detail, is to provide a moveable feet-massage grabbing bar rack which has many novel features that result in a moveable feet-massage grabbing bar rack which is not anticipated, rendered obvious, suggested, or even implied by prior art, either alone or in combination thereof.

Ahiatsu, or “walking-massage” or “feet-massage”, as used herein throughout, is an ancient art employed to relieve lumber discomfort and strain by effectively decompressing the spine and increasing blood flow to the spinal cord and associated anatomy. Ahiatsu is administered by a massager applying their bodyweight to a prostrate or supine patient by standing upon the patient barefoot, and applying pressure with the feet to targeted locations. Incorrect technique can be injurious to the patient, causing chronic and even irreparable harm.

Massagers typically suspend themselves from a transverse support overhead to regulate application of their weight to prostrate patients. By manually engaging the transverse support, massagers can regulate applied bodyweight by action of their arms controlling and releasing their bodyweight to the patient underneath their feet, in conjunction with targeted steps and action of the feet into the dorsal tissue adjacent and proximal the spine.

The present moveable feet-massage grabbing bar rack has been devised to enable a massager to erect a secure support frame that positions a grabbing bar assembly spanning a desired location whereat a patient may lay prostrate. The present moveable feet-message grabbing bar rack enables securable positioning of the grabbing bar assembly between a plurality of positions whereby a desired height for a particular massager and patient is attainable. The present moveable feet-massage grabbing bar rack is devised so that a massager can use the grabbing bar assembly to support their bodyweight by direct contact with the massager torso, with one of a pair of parallel bars disposed under the arms, for example, and by manual engagement with a transverse support overhead, as is seen commonly in the art. The present moveable feet-massage grabbing bar rack is configured to be lightweight and, when disassembled, readily ported to a desired location, and there quickly erected for use.

The present moveable feet-massage grabbing bar rack, therefore, includes a first and second side stand, positional in parallel array spaced apart and secured together by a grabbing bar assembly secuarbly fittable spanned therebetween. Each of the first and second side stands includes a horizontal floor beam, a vertical upright beam, and a pair of strut members diagonally disposed between the floor beam and upright beam to supportively uphold the upright beam perpendicularly disposed relative the floor beam.

The floor beam is longitudinally disposed upon a ground surface in parallel with a patient laying prostrate (or supine) proximal thereto. The floor beam includes a pair of ends and a midpoint equidistantly disposed between each of the pair of ends. The upright beam is endwise disposed perpendicularly upon the floor beam at the midpoint. Each of the pair of side struts is disposed on either side of the upright beam, conjoining the floor beam at a position between one of the pair of ends and the midpoint. Each of the pair of side struts supports the upright beam in perpendicular position at the floor beam midpoint.

The upright beam of each of the first and second side stands includes an upper portion whereat the grabbing bar assembly is selectively attachable between a range of positions, as will be described subsequently. The grabbing bar assembly is thus attachable to the upper portion of the upright beam of each of the first and second side stands in perpendicular array relative each floor beam and upright beam whereby the present moveable feet-message grabbing bar rack is erectable into a self-standing and stable structure spanning a patient prostrate between each of said first and second side stands.

The grabbing bar assembly includes a pair of parallel bars endwise interconnected with each of a pair of vertical strut members. Each of the pair of parallel bars are contemplated to by cylindrically shaped with a rounded transverse cross-section conformable to grasping and manual engagement by a user and for contact with the user's torso when applying bodyweight to the bars. Each of the pair of parallel bars is oriented to span horizontally, vertically aligned, between the upper portion of the upright beam of each of the first and second side stands when an attachment section, disposed upon each of the vertical strut members, is caused to securably attach to an associated upper portion.

The attachment section of each of the pair of vertical strut members includes a plurality of interconnection points disposed to align and effect securement to each of a plurality of anchor points disposed vertically serried upon each upper portion. Interposition of each of the plurality of interconnection points with each of the plurality of anchor points enables selective securement across a range of positions, whereby the height of the pair of parallel bars above a ground or other surface is selectable.

In an example embodiment contemplated herein, the upper portion of the upright beam of each of the first and second side stands may be extendible vertically upwards endwise out of the associated upright beam and securable at a desired extension. Subsequent attachment of the grabbing bar assembly to the upper portion thence enables an increased range of positions in which the pair of parallel bars may be desirously positioned.

Disassembly of the present moveable feet-massage grabbing bar rack subsequent use enables a compact arrangement of parts for ready portage. In an example embodiment herein contemplated, the first and second side stands comprise hollow aluminum tubes having a square transverse cross-section, however additional lightweight materials with high tensile strengths (capable of supporting a human body thereon without deformation) are contemplated as part of this disclosure, such as, for example, other metal, metallic, compound, or polymeric materials.

Thus has been broadly outlined the more important features of the present moveable feet-massage grabbing bar rack so that the detailed description thereof that follows may be better understood and in order that the present contribution to the art may be better appreciated.

Objects of the present moveable feet-massage grabbing bar rack, along with various novel features that characterize the invention are particularly pointed out in the claims forming a part of this disclosure. For better understanding of the moveable feet-massage grabbing bar rack, its operating advantages and specific objects attained by its uses, refer to the accompanying drawings and description.

### BRIEF DESCRIPTION OF THE DRAWINGS

FIGURES

FIG. 1 is an isometric view of an example embodiment.

FIG. 2 is a side view of an example embodiment of a first side stand.

FIG. 3 is a front view of an example embodiment of a first side stand.

FIG. 4 is a cross-section view of an example embodiment of a first side stand taken along the line A-A of FIG. 2.

FIG. 5 is a front view of an example embodiment of a grabbing bar assembly.

FIG. 6 is a cross-section view of an example embodiment of one of a pair of parallel bars, taken along the line A-A of FIG. 5.

FIG. 7 is a cross-section view of an example embodiment of one of a pair of vertical strut members, taken along the line B-B of FIG. 5.

FIG. 8 is an isometric view of an example embodiment.

FIG. 9 is an isometric view of an example embodiment having upper portions of upright beams of each of a first and second side stand vertically extendible from out the associated upright beam.

### DETAILED DESCRIPTION OF THE DRAWINGS

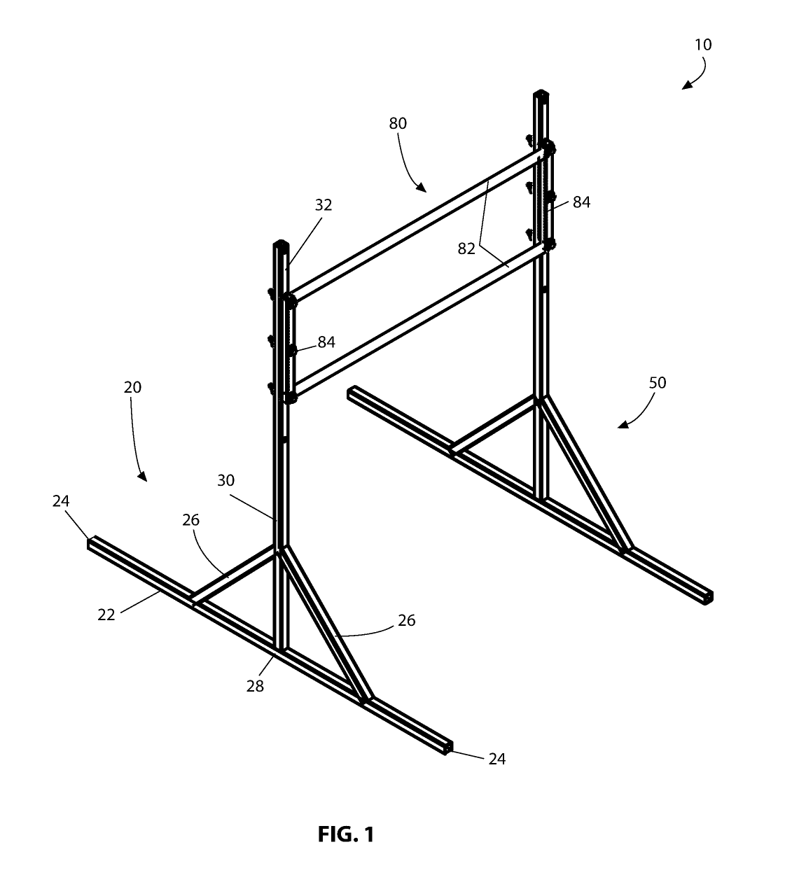

With reference now to the drawings, and in particular FIGS. 1 through 9 thereof, example of the instant moveable feet-massage grabbing bar rack employing the principles and concepts of the present moveable feet-massage grabbing bar rack and generally designated by the reference number 10 will be described.

Referring to FIGS. 1 through 9 an example embodiment of the present moveable feet-massage grabbing bar rack 10 is illustrated.

The present moveable feet-massage grabbing bar rack 10 has been devised to enable a user to perform a feet-walking massage upon a prostrate or supine patient without requiring any permanent installation at any single location. The present moveable feet-massage grabbing bar rack 10 is portable and erectable at a desired location to secure a grabbing bar assembly 80 at a desired height spanned between each of a first and second side stand 20, 50 whereby a patient, prostrate upon a massage table or a mat upon the floor for example, is enabled receipt of a walking massage by a user engaging the grabbing bar assembly 80 to apply bodyweight to said grabbing bar assembly 80 securably positioned at a height appropriate for said user to properly perform the walking massage without injuring the patient, whether said patient is lying upon a massage table, or other raised structure, or is prostrate upon a mat upon the floor. Further, the present grabbing bar assembly 80 is securable between a plurality of positions upon each of the first and second side stands 20, 50, as will be described subsequently, whereby the user may reposition the grabbing bar assembly 80 to lean their torso directly against said grabbing bar assembly or to perform knee massage as well as walking massage.

The present moveable feet-massage grabbing bar rack 10, therefore, includes a first side stand 20, a second side stand 50, and a grabbing bar assembly 80. Each of the first and second side stand 20, 50 includes a horizontal floor beam 22, a vertical upright beam 30, and a pair of strut members 26.

The floor beam 22 includes a pair of ends 24 and a midpoint 28. The vertical upright beam 30 is disposed perpendicularly endwise at the floor beam 20 midpoint 28 to maintain an upper portion 32 aloft vertically situated above the floor beam 22 midpoint 28. Each of the pair of strut members 26 is angularly disposed diagonally connecting the upright beam 30 to the floor beam 20 between the midpoint 28 and one of the pair of ends 24. Each of the first and second side stands 20, 50 is therefore positional spaced apart with each of the associated upright beams 30 disposed in parallel relation.

The first and second side stands 20, 50 are contemplated to be manufactured of aluminum square-tube, or another lightweight, hollow metal or polymer, whereby the weight of each of the first and second side stands 20, 50 is controllable within acceptable norms for portability yet tensile strength and rigidity is maintained capable of supporting an adult human suspended from the grabbing bar assembly 80 when said grabbing bar assembly 80 is secured spanning between each of the first and second side stands 20, 50.

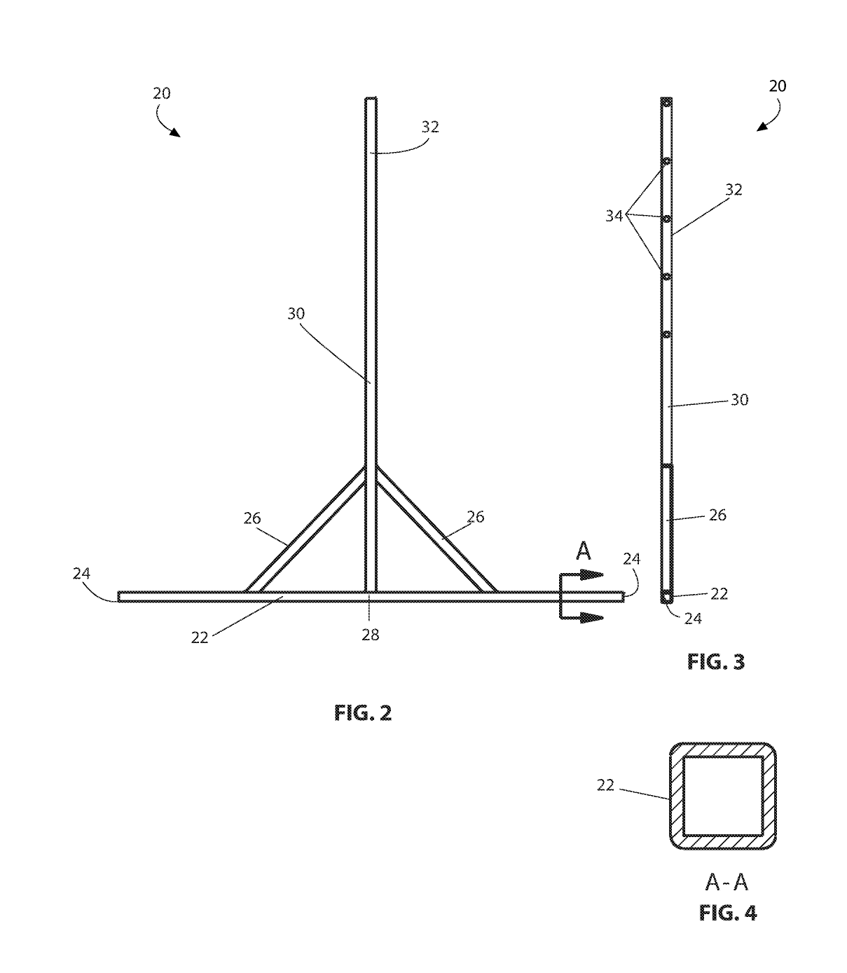

As shown in an example embodiment depicted in FIG. 4, the transverse cross section of the first and second side stands 20, 50 is configured to be a square of one inch sides. Referring to FIG. 2, the length of each floor beam 20 is contemplated to be forty-eight (48) inches, and the distance between each of the pair of strut members 26, at the point of conjunction with the floor beam 20, is taken to be twenty-four (24) inches. The height at which each of the pair of strut members 26 conjoins with the upright beam 30 is taken to be twelve (12) inches, making the length of each strut member 26 approximately 16.97 inches. In this embodiment, the length of the upright beam 30 is taken to be at least forty-eight (48) inches.

The grabbing bar assembly 80 is attachable to the upper portion 32 of the upright beam 30 of each of the first and second side stands 20, 50. When secured to each of the first and second side stands 20, 50, the grabbing bar assembly 80 is disposed in a plane perpendicular to each floor beam 22 and each upright beam 30. The grabbing bar assembly 80 thus fixes the first and second side stands 20, 50 together to prevent toppling, securably spanning between each of said first and second side stands 20, 50.

The grabbing bar assembly 80 includes a pair of parallel bars 82 disposed spaced apart and endwise connected to each of a pair of vertical strut members 84. As shown in FIG. 6, each of the pair of parallel bars 82 is contemplated to be cylindrical with a round transverse cross-section, the better for grasping comfort by a user manually engaging each of the pair of parallel bars 82 and contacting said pair of parallel bars 82 with the torso or underarm. In the example embodiment depicted in FIG. 6, each of the pair of parallel bars 82 has a radius of one (1) inch.

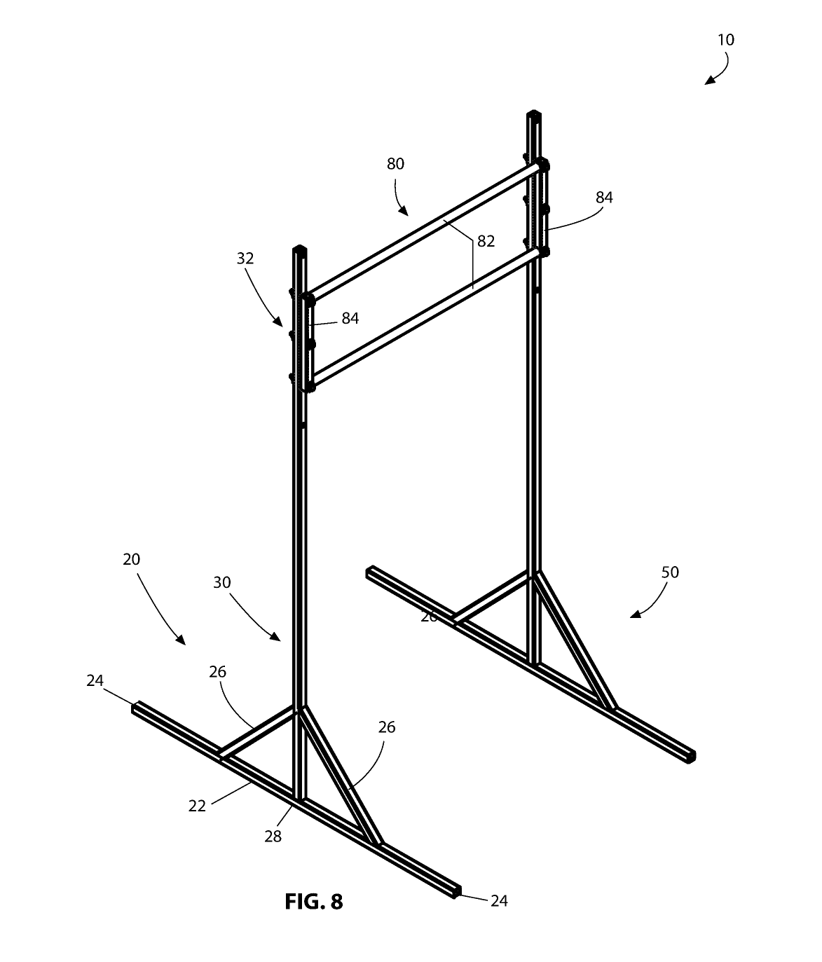

The transverse cross-section of each of the pair of vertical strut members 84, however, as shown in FIG. 7, is contemplated to be square, whereby each of the pair of vertical strut members 84 includes an attachment section 86 positional in flush contact with the upright beam 30 upper portion 32 of each of the first and second side stands 20, 50. In the example embodiment shown in FIG. 7, the square cross section is a one-inch square.

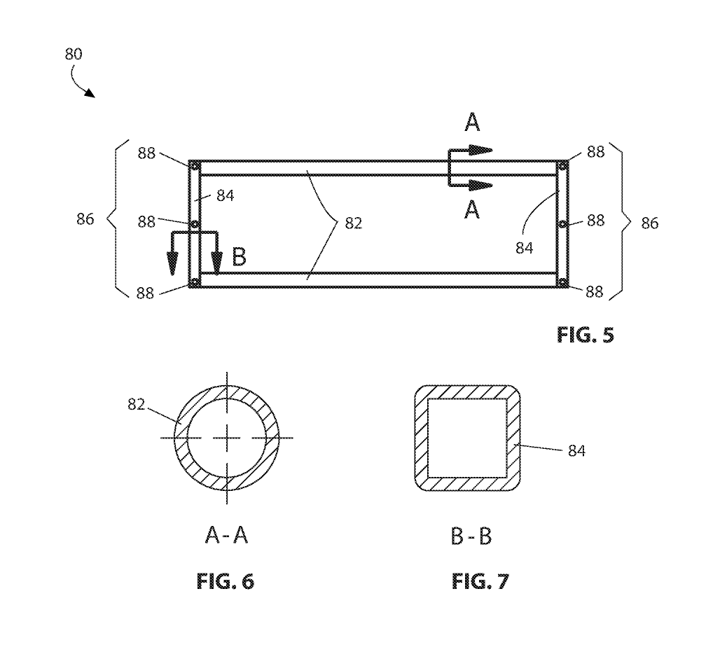

In the example embodiment depicted in FIG. 5. the length of each of the pair of parallel bars 82 is contemplated to be thirty-six (36) inches, and the length of each of the pair of vertical strut members 84 is contemplated to be twelve (12) inches. Thus, in this embodiment, the pair of parallel bars 82 is disposed approximately twelve (12) inches apart.

The upper portion 32 of the upright beam 30 of each of the first and second side stands 20, 50 includes a plurality of anchor points 34 to which each attachment section 86 of the pair of vertical strut members 84 is securable at each of a corresponding plurality of interconnection points 88. Alignment of one of the plurality of interconnection points 88, therefore, with a desired one of the plurality of anchor points 34 enables securement of the grabbing bar assembly 80 at a desired height relative a ground surface, for example, or above a patient prostrate between the first and second side stands 20, 50.

In the example embodiment shown in FIG. 3, the plurality of anchor points 34 upon the upper portion 32 comprises a plurality of holes disposed five-and-one-half (5.5) inches apart serried vertically thereupon. As shown in FIG. 5 each of the plurality of interconnection points 88 disposed upon the attachment section 86 of each of the pair of vertical strut members 84 also comprises a plurality of holes disposed five-and-one-half (5.5) inches apart vertically serried thereupon, whereby alignment of any two of the plurality of interconnection points 88 with any corresponding two of the plurality of anchor points 34 enables securement of the grabbing bar assembly 80 by action of a fastener secured therethrough. The pair of parallel bars 82 is thus securable between a range of positions through approximately at least eleven (11) inches.

It should be readily understood by anyone having skill in the pertinent art that additional means of securement of the grabbing bar assembly 80 into a range of positions are contemplated as part of this disclosure, including, for example action of a plurality of ball detents effected between each of the plurality of anchor points 34 and each of the plurality of interconnection points 88, likewise action of pins, clips, quick-release members, and other such fasteners contemplated as part of this disclosure.

Each of the pair of vertical strut members 84 attachment section 86 is securable to the upper portion 32 of the upright beam 30 of each of the first and second side stands 20, 50 to securably position the pair of parallel bars 82 at a desired height spanned between each of the first and second side stands 20, 50. Thus a user may erect the moveable feet-massage grabbing bar rack 10 at a preferred location to perform a walking massage on a patient prostrate between each of the first and second side stands 20, 50. Moreover, the height of the grabbing bar assembly 80 is securable between a range of positions and may therefore be altered expediently for knee massage, for example, or to compensate for a patient prostrate on a floor mat or upon a massage table, for example, or other raised structure, as case may be.

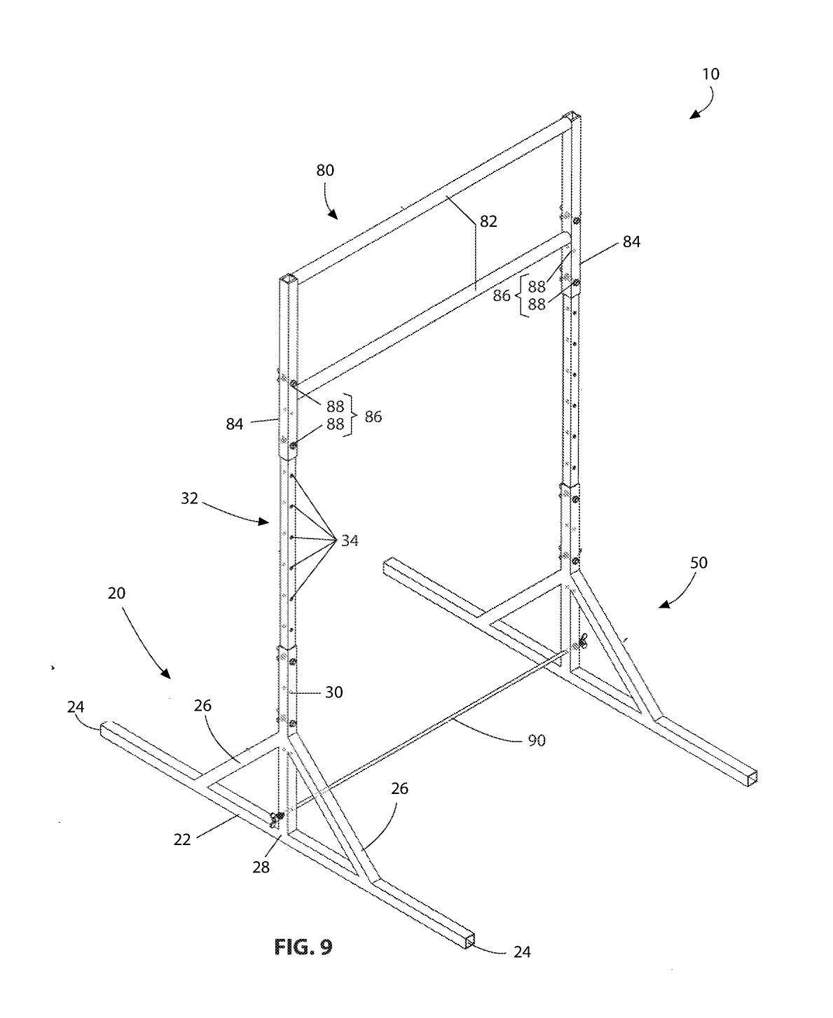

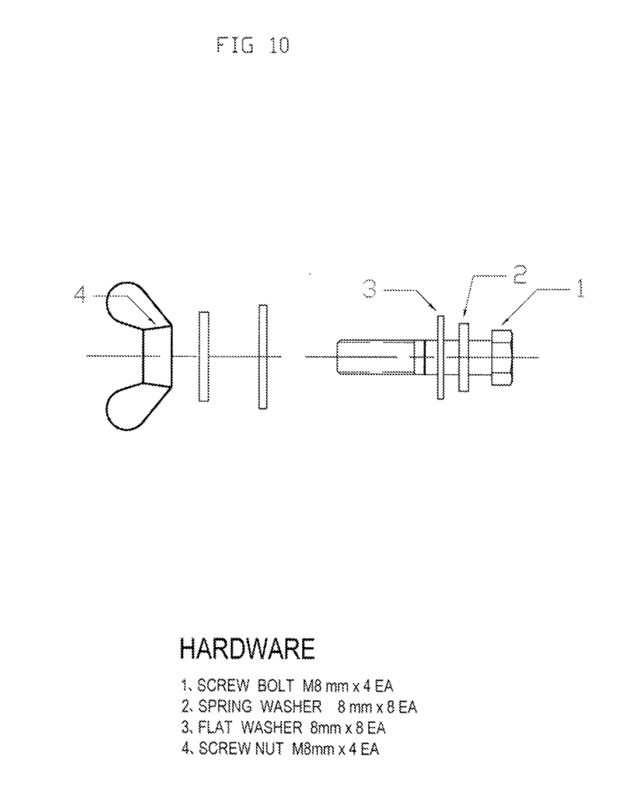

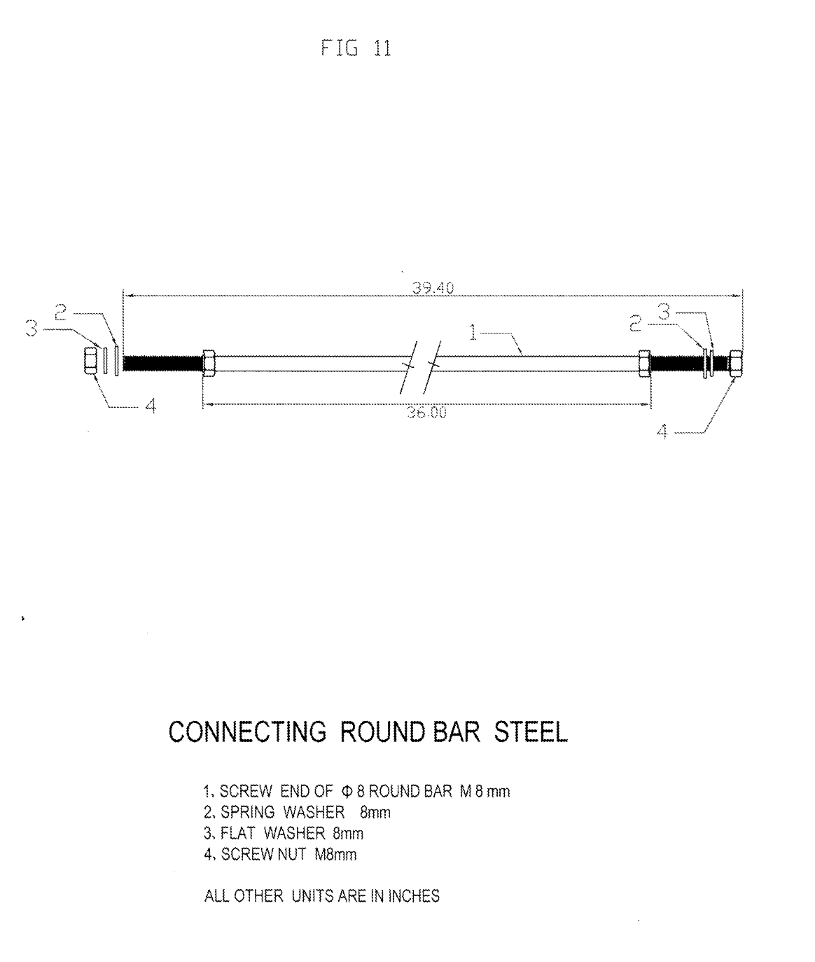

In another embodiment shown in FIG. 9, the upper portion 32 of the upright beam 30 of each of the first and second side stands 20, 50 is extendible vertically upwards out the upright beam 30. In this embodiment, the upper portion 32 has a transverse cross-section lesser in length than the transverse cross-section of the upright beam 30 and each of the pair of vertical strut members 84 of the grabbing bar assembly 80. The upper portion 32 is thus slidingly positional interior to each upright beam 30 and an associated one of the pair of vertical strut members 84. The plurality of anchor points 34 in this embodiment enables selective position and securement of the upper portion 32 at a desired extension from out the upright beam 30, as well as securement of the attachment section 86 of each of the pair of vertical strut members 84 to secure the grabbing bar assembly 80 at a desired position upon the upper portion 32 itself, whereby the range of positions and associated height of the grabbing bar assembly 80 is thereby increased.

Due to the increased height enabled by this embodiment, strengthening bar 90 may be included, securable between the floor beams 22 of each of the first and second side stands 20, 50 in a position proximal each midpoint 28.

What is claimed is:

1. A moveable feet-massage grabbing bar rack comprising:
a first side stand having:
a horizontal floor beam, said horizontal floor beam having a pair of ends and a midpoint;
a vertical upright beam having an upper portion, said upright beam disposed perpendicularly endwise at the floor beam midpoint;
a pair of strut members angularly disposed connecting the upright beam to the floor beam, each of said pair of strut members diagonally disposed endwise between the floor beam midpoint and one of the floor beam pair of ends;
a second side stand substantially similar to the first side stand, said second side stand comprising:
a horizontal floor beam, said horizontal floor beam having a pair of ends and a midpoint;
a vertical upright beam having an upper portion, said upright beam disposed perpendicularly endwise at the floor beam midpoint;
a pair of strut members angularly disposed connecting the upright beam to the floor beam, each of said pair of strut members diagonally disposed endwise between the floor beam midpoint and one of the floor beam pair of ends; and
a grabbing bar assembly connectable to the upper portion of each of the first and second side stand upright beams, said grabbing bar assembly having a pair of parallel bars disposed spaced apart and endwise connected to each of a pair of vertical strut members, said pair of vertical strut member including attachment sections interconnectable with the upper portion of each of the pair of upright beams;
wherein the grabbing bar assembly is movably securable to each of the upper portions of each of the first and second side stands within a range of positions delimited by the extent of each said upper portion, whereby a rigid structure is erectable to position the grabbing bar assembly at a desired height secured between each of the first and second side stands and a user is thereby supportable by underarm engagement along the lengths of each of the pair of parallel bars to effect a walking massage upon a patient lain thereunder.

2. The moveable feet-massage grabbing bar rack of claim 1 wherein each of the pair of parallel bars of the grabbing bar assembly has a round transverse cross-section.

3. The moveable feet-massage grabbling bar rack of claim 2 wherein each of the pair of vertical strut members of the grabbing bar assembly has a square transverse cross-section.

4. The moveable feet-massage grabbing bar rack of claim 3 wherein each of the to first and second side stands are sized appropriate to secure the grabbing bar assembly transversely spanned above an existing massage table whereby the walking massage is performable upon a patient lain upon the massage table.

5. The moveable feet-massage grabbing bar rack of claim 4 wherein the upper portion of the upright beam of each of the first and second side stands includes a plurality of anchor points, each of said plurality of anchor points securable to a corresponding plurality of interconnection points disposed upon the grabbing bar assembly.

6. The moveable feet-massage grabbing bar rack of claim 5 wherein each of the pair of vertical strut members of the grabbing bar assembly slides over each of the pair of upright beams of each of the first and second side stands, said grabbing bar assembly thereby securable at a desired height by alignment of the plurality of interconnection points with corresponding ones of the plurality of anchor points.

7. The moveable feet-massage grabbing bar rack of claim 6 wherein upper portion of the upright beam of each of the first and second side stands is extendable upwards and endwise from inside the associated upright beam, said upper portion thence securable at each of a plurality of positions of upward extension whereby the grabbing bar assembly, securable to the upper portion at the plurality of anchor points, is further positional between a plurality of positions to vertically disposed transversely spanning between each of the first and second side stands.
